(19) United States
(12) Patent Application Publication
(10) Pub. No.: US 2011/0053604 A1
(43) Pub. Date: Mar. 3, 2011

(54) SCHEDULING METHOD BASED ON HIERARCHICAL CELL STRUCTURE AND FEMTO BASE STATION FOR THE SAME

(76) Inventors: Byoung Hoon Kim, Anyang-si Gyeonggi-do (KR); Seo Woo Jang, Anyang-si Gyeonggi-do (KR); Jae Won Lim, Anyang-si Gyeonggi-do (KR); Jun Ho Jo, Anyang-si Gyeonggi-do (KR)

(21) Appl. No.: 12/863,975

(22) PCT Filed: Jul. 28, 2009
(86) PCT No.: PCT/KR2009/004186

§ 371 Date: Jul. 21, 2010

Related U.S. Application Data
(60) Provisional application No. 61/169,730, filed on Apr. 16, 2009.

(51) Int. Cl. H04W 72/00

(52) U.S. Cl. 455/450

(57) ABSTRACT

A method for scheduling User Equipments (UEs) in a femto Base Station (BS) in a mobile communication system having a hierarchical cell structure is disclosed. The scheduling method includes transmitting a resource allocation request signal to a macro BS using a predetermined identifier (ID) having a UE ID format, receiving radio resource allocation information about resources allocated in relation to the predetermined ID from the macro BS, allocating the allocated radio resources to one or more UEs, receiving a signal from the one or more UEs using the allocated radio resources, and transmitting the signal received from the one or more UEs to a network via an Internet connection.

### TECHNICAL FIELD

The present invention relates to a method for efficiently scheduling radio resources for User Equipments (UEs) based on a hierarchical cell structure in a mobile communication system and a femto Base Station (BS) for performing the same.

### BACKGROUND ART

Active studies have recently been conducted to expand coverage in a mobile communication system. A femto BS or a femto cell has been proposed as a small indoor access point for low-power home use or office use.

The femto BS is a small cellular BS connected to a broadband router and functions to connect 2^{nd} Generation (2G) and 3^{rd} Generation (3G) voice and data to a backbone network of a mobile communication service provider via the Digital Subscriber Line (DSL.)

Femto BSs have accelerated 3G proliferation. They can be a driving force behind expansion of indoor coverage. It is expected that 100 millions of or more users will use terminals supporting femto cells in a few years and 30 millions of femto BSs will be installed. From a technological aspect, reinforcement of indoor coverage from technologies such as Wideband Code Division Multiple Access (WCDMA), High Speed Downlink Packet Access (HSDPA), and Evolution-Data Only (EV-DO) is very critical to service provision. Routing traffic over an Internet Protocol (IP) network increases network quality and accommodability and save operation cost that mobile communication service providers expend on backhaul dedicated links, advantageously from the perspective of strategy and economy.

Along with the use of femto BSs, a communication system supporting multiple UEs is configured in a hierarchical cell structure.

FIG. 1 illustrates a communication system having a hierarchical cell structure along with the use of femto BSs.

Referring to FIG. 1, a macro cell 100 may include a plurality of femto cells 110a to 110d and each femto cell, for example, the femto cell 110a may service one or more UEs, for example, UEs 120a and 120b within its cell area. Among a plurality of UEs 120a to 120h within the macro cell 100, UEs 120e to 120h are serviced directly by a macro BS 130 and UEs 120a to 120d are serviced by the macro BS 130 through femto BSs 140a to 140d.

In general, the term “cell” indicates the coverage of a certain access point. Yet, hereinbelow, “cell” is meant to be a certain access point itself, unless confusing.

Femto cells are different from relay stations in that the femto cells can not be connected directly to one another in configuring a Self Optimizing Network (SON) and also in that the femto cells can transmit communication signals from UEs directly to a service provider network without the intervention of a macro cell. Unlike the macro cell, the femto cells can be turned on/off and operate in sleep mode to save power.

The femto cells may be categorized into Closed Subscriber Group (CSG) femto and Open Subscriber Group

(OSG) femto according to the characteristics of UEs that access them. A CSG femto BS groups UEs that can access it, allocates CSG Identifiers (IDs) to the UEs by group, and allows access only from the UEs to which the CSG IDs have been allocated. An OSG femto BS is accessible to all UEs.

The term “femto BS” may be replaced with other terms such as “Home Node B (HNB)”, “evolved Home Node B (eHNB), etc. Although there is a slight difference between femto cell and pico cell in that a new wired control message is needed or not or in other respects, it is assumed that the femto cell conceptually covers the pico cell, hereinbelow.

A mobile communication system that has a hierarchical cell structure due to the use of the above-described femto cells may schedule radio resources for a plurality of UEs (and femto BSs) in various manners. Yet, it is necessary to specify a method for efficiently scheduling radio resources based on the afore-described hierarchical cell structure, while minimizing a modification to a legacy system.

### DISCLOSURE

### Technical Problem

An object of the present invention devised to solve the problem lies on a method for efficiently implementing hierarchical radio resource scheduling using a femto BS, minimizing a modification to a legacy system, and conducting communications based on the hierarchical scheduling in a mobile communication system.

Another object of the present invention devised to solve the problem lies on a femto BS for supporting hierarchical scheduling.

### Technical Solution

The object of the present invention can be achieved by providing a method for scheduling UEs in a femto BS in a mobile communication system having a hierarchical cell structure, the method including transmitting a resource allocation request signal to a macro BS using a predetermined ID having a UE ID format, receiving radio resource allocation information about resources allocated in relation to the predetermined ID from the macro BS, allocating the allocated radio resources to one or more UEs, receiving a signal from the one or more UEs using the allocated radio resources, and transmitting the signal received from the one or more UEs to a network via an Internet connection.

The mobile communication system may provide a service to a plurality of UEs and the plurality of UEs may be grouped into a macro UE group serviced directly by the macro BS and a femto UE group serviced by the femto BS.

The femto BS may wirelessly communicate with the macro BS, the one or more UEs may be included in the femto UE group, and the femto BS may transmit a signal to the one or more UEs in the allocated radio resources.

The allocated radio resources may be confined to communications between the femto BS and the one or more UEs included in the femto UE group.

The transmission may include transmitting the signal received from the one or more UEs directly to the network via the Internet connection without making the signal pass through the macro BS.

The predetermined ID may be a UE ID allocated to the femto BS by the macro BS. The UE ID may be used as a group ID of the one or more UEs. The predetermined ID may be an ID of one of the one or more UEs.

The one or more UEs may communicate with another UE using the allocated radio resources.

The method may further include transmitting to the macro BS information by which the macro BS distinguishes the femto BS from the plurality of UEs, and the macro BS may allocate the radio resources allocated to the femto BS to another femto BS.

The method may further include transmitting neighbor femto BS information to a central controller, and the central controller may allocate the radio resources allocated to the femto BS to another femto BS.

In another aspect of the present invention, provided herein is a femto BS in a mobile communication system that has a hierarchical cell structure and provides a service to a plurality of UEs, the femto BS including a macro communication module for transmitting a resource allocation request signal to a macro BS using a predetermined ID having a UE ID format and receiving radio resource allocation information about radio resources allocated in relation to the predetermined ID from the macro BS, a user communication module for allocating the radio resources allocated by the macro BS to one or more UEs and receiving a signal from the one or more UEs using the allocated radio resources, and a network communication module for transmitting the signal received from the one or more UEs to a network via an Internet connection.

The macro communication module and the user communication module may be cellular mobile communication modules and the network communication module may be a DSL-based Internet communication module.

### ADVANTAGEOUS EFFECTS

Exemplary embodiments of the present invention implement hierarchical radio resource scheduling efficiently, while minimizing a modification to a legacy system.

Also, communications can be conducted between UEs within a femto cell and spatial reuse can be achieved, based on the property that radio resources allocated to a femto BS are confined to a femto cell under management of the femto BS.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates a communication system configured in a hierarchical cell structure using femto BSs.

FIG. 2 illustrates a communication method in which a macro cell allocates resources to a femto BS like a UE and the femto BS carries out communications within a femto cell according to an exemplary embodiment of the present invention.

FIG. 3 conceptually illustrates a hierarchical scheduling method from the viewpoint of a BS scheduler according to an exemplary embodiment of the present invention.

FIG. 4 illustrates the concept of allocating radio resources and conducting communications in the allocated radio resources in a hierarchical scheduling method according to an exemplary embodiment of the present invention.

FIG. 5 illustrates a concept of radio resource allocation according to an exemplary embodiment of the present invention.

FIGS. 6 and 7 illustrate a radio resource scheduling method taking into account spatial reuse according to another exemplary embodiment of the present invention.

FIG. 8 is a view comparing a femto BS-based scheduling method according to an exemplary embodiment of the present invention with a relay station-based scheduling method.

FIG. 9 is a block diagram of a femto BS according to an exemplary embodiment of the present invention.

### BEST MODE

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following description is made with the appreciation that a terminal generically refers to a fixed or mobile user device such as a User Equipment (UE), a Mobile Station (MS), etc. Also, it is assumed that the term “femto BS” covers “pico BS” as well as “Home Node B (HNB)” and “evolved Home Node B (eHNB)” in its meaning.

A mobile communication system that has a hierarchical cell structure due to use of femto cells may schedule radio resources for a plurality of UEs (and femto BSs) in various manners. Table 1 below illustrates exemplary scheduling scenarios that can be addressed in the hierarchical cell structure.

TABLE 1

| | | |
|---|---|---|
| TIME | Avoid | CR-Grey Space |
| | Co-Exist | TDD Superframe-dedicated time |
| FREQUENCY | Avoid | CR-White Space |
| | Co-Exist | Dedicated Frequency, |
| | | Frequency Hopping |
| TIME & | Avoid | CR-Multichannel white/grey |
| FREQUENCY | space | |
| | Co-Exist | Hybrid Scheduling |

In Table 1, the first row describes a method of allocating radio resources such that the same radio resources are not allocated to a plurality of UEs (and femto BSs) in the time domain (Avoid) and a method of allocating the same radio resources in the time domain (Co-Exist). The former method may use a radio resource area (grey space) that is a frequency band set for a particular service but available intermittently in the time domain, using a Cognitive Radio (CR) technology. On the other hand, the latter method may use a Time Division Duplex (TDD) superframe occupying a dedicated time area.

The second row describes a method of allocating radio resources such that the same radio resources are not allocated to a plurality of UEs (and femto BSs) in the frequency domain (Avoid) and a method of allocating the same radio resources in the frequency domain (Co-Exist). The former method may use a frequency band (white space) that is not used for any service, by the CR technology. On the other hand, a dedicated frequency area may be allocated to each UE or a femto BS, while allowing co-existence in the frequency area by frequency hopping or the like in the latter method.

The third row describes a method of allocating radio resources such that the same radio resources are not allocated to a plurality of UEs (and femto BSs) in the time and frequency domains (Avoid) and a method of allocating the same radio resources in the time and frequency domains (Co-Exist). The former method may use a CR technology based on multi-channel white/gray space. On the other hand, the latter method may be implemented in a hybrid manner by using a TDD superframe occupying a predetermined time area and using frequency hopping, while allocating a dedicated frequency band.

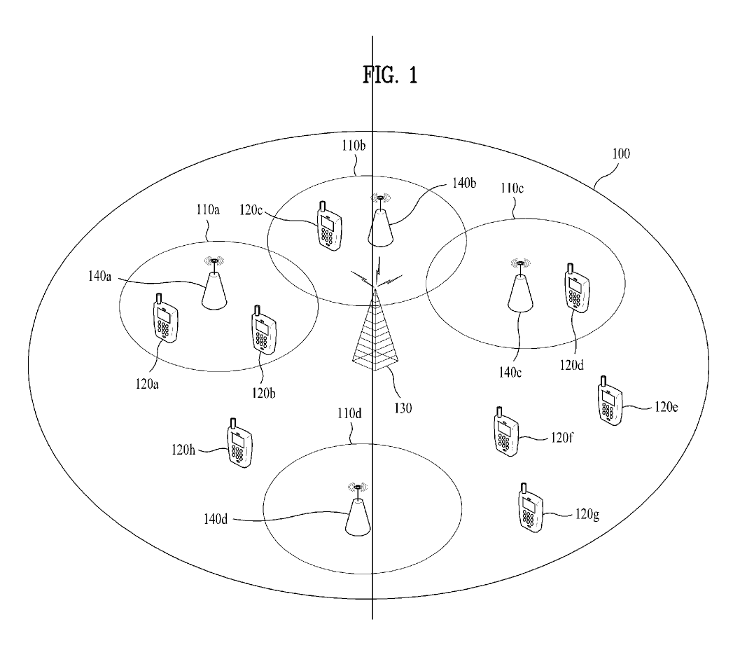

An exemplary embodiment of the present invention seeks to minimize a modification to a legacy system, preferably keep a macro BS unchanged in applying the above-described radio resource allocation schemes to a system having the hierarchical cell structure described with reference to FIG. 1. A Self Organizing Network (SON) is a network configures topologies by itself. The functions performed by the SON comprise a self optimizing and a self healing. To implement these SON function, a method for enabling a femto BS to be allocated radio resources from a macro BS, like a UE and to use the radio resources for communications with one or more UEs serviced by the femto BS in accordance with an exemplary embodiment of the present invention.

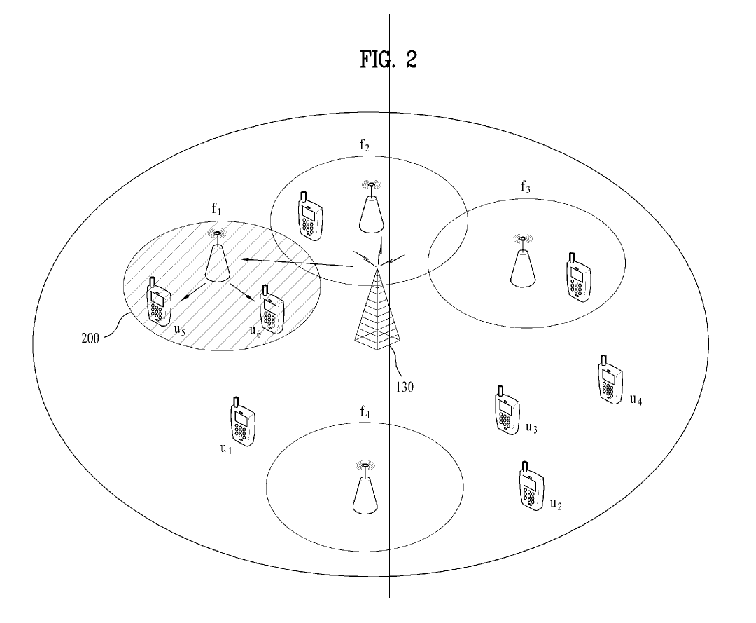

FIG. 2 illustrates a method for being allocated resources from a macro BS, like a UE and conducting communications within a femto cell in a femto BS according to an exemplary embodiment of the present invention.

In the exemplary embodiment of the present invention, it is proposed that a femto BS f₁ requests radio resource allocation to a macro BS 130, like a UE that is allocated radio resources from the macro BS 130. To do so, the femto BS f₁ requests the radio resource allocation to the macro BS 130, preferably using a predetermined Identifier (ID) having a UE ID format. The macro BS 130 may allocate radio resources to the femto BS f₁ in response to the predetermined ID in the same manner as it allocates radio resources to a UE. That is, the macro BS 130 does not need to distinguish the femto BS f₁ from UEs, when it allocates radio resources.

In a 3GPP LTE system, for example, a femto BS may request resource allocation to a macro BS by an ID such as a Cell Radio Network Temporary Identifier (C-RNTI), a semi-persistent scheduling C-RNTI, or a temporary C-RNTI and be allocated radio resources from the macro BS in response to the ID. However, the UE ID format according to the exemplary embodiment of the present invention is not limited, as far as it is available in a BS's identifying a UE in a mobile communication system.

When the femto BS f₁ is allocated radio resources from the macro BS 130, it may communicate with a UE wirelessly using the radio resources within its coverage area. Notably, the use of the radio resources allocated to the femto BS f₁is confined to communications between the femto BS f₁ and UEs u₅ and u₆ in a femto cell area 200 serviced by the femto BS f₁. Hence, the radio resources are not used for communications between the femto BS f₁ and the macro BS 130 or in any other femto cell area. In other words, the femto BS f₁ is characterized by transmitting signals received from the UEs u₅ and u₆ directly to a network of a communication service provider via an Internet connection as over a DSL network, rather than by transmitting the received signals to the macro BS 130 using the allocated radio resources.

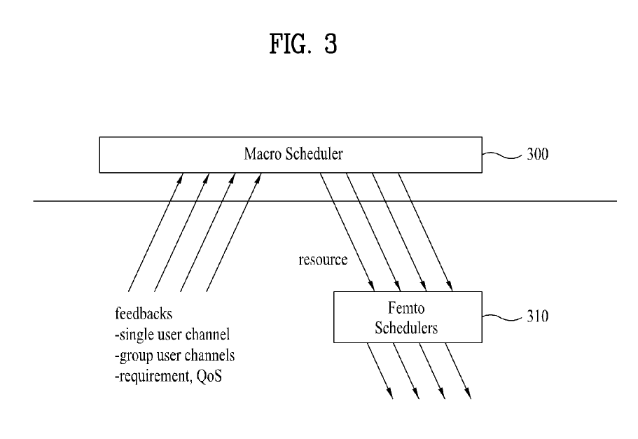

FIG. 3 conceptually illustrates a hierarchical scheduling method from the viewpoint of a macro BS scheduler according to an exemplary embodiment of the present invention.

Referring to FIG. 3, a macro BS scheduler or macro scheduler 300 receives a resource allocation request signal or resource allocation request signals from a UE or UEs. In accordance with the exemplary embodiment of the present invention, it is assumed that a plurality of UEs that are serviced in a mobile communication system are grouped into a macro UE group that a macro BS directly services and a femto UE group that femto BSs service. Each UE may transmit single user channel information, Quality of Service (QoS), etc. as feedback information for a resource allocation request to the macro BS. Like the UE, a femto BS requests resource allocation to the macro scheduler 300 in the same manner in the exemplary embodiment of the present invention. Thus, the femto BS may transmit group user channel information, QoS information, etc. about an associated femto UE group to the macro BS, as the UE does. The femto BS preferably receives a pilot signal or a reference signal from the macro BS and reports its channel status periodically or non-periodically to the macro BS. It is also preferable that the femto BS performs a procedure for a UE's acquiring ID information within a cell or an equivalent procedure in order to use an ID having a UE ID format in requesting resource allocation in the exemplary embodiment of the present invention. An ID having the UE ID format, available to the femto BS, may be an ID of a specific UE within the femto UE group or an ID allocated to the femto BS as a group ID of the femto UE group.

Meanwhile, there is no need for determining whether an entity requesting radio resources is a UE or a femto BS on the part of the macro scheduler 300. The macro scheduler 300 allocates radio resources to the UE or the femto BS based on feedback information received from the UE or the femto BS.

If the femto BS has requested radio resources, a scheduler of the femto BS or femto scheduler 310 may allocate the radio resources to a UE within its femto cell, for wireless communications within the femto cell.

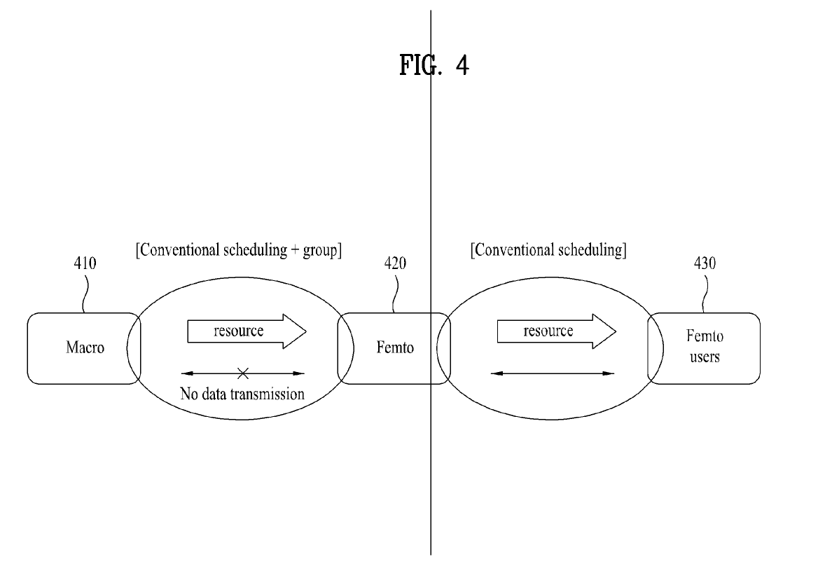

Since the femto BS is allocated resources in the same manner as a UE is and in turn allocates the resources to a UE or UEs included in its femto UE group, the radio resource allocation is efficient without incurring a modification to the macro BS. In contrast, regarding a relay station, the macro BS needs to identify the relay station for radio resource allocation and a radio frame used by the macro BS needs to be modified for the relay station. The hierarchical scheduling scheme according to the exemplary embodiment of the present invention may be compared to a scheduling scheme for a relay station, in terms of use of allocated radio resources, which will be described below with reference to FIG. 4.

FIG. 4 illustrates the concept of allocating radio resources and conducting communications in the allocated radio resources in a hierarchical scheduling method according to an exemplary embodiment of the present invention.

Referring to FIG. 4, a femto BS 420 is allocated radio resources from a macro BS 410 in the same manner as a UE is conventionally allocated radio resources from the macro BS 410. Accordingly, there is no need for a particular modification to the macro BS 410 in applying the hierarchical scheduling scheme according to the exemplary embodiment of the present invention. In the mean time, the femto BS 420 in turn allocates the radio resources to UEs 430 of a femto UE group serviced by the femto BS 420. The femto BS 420 may receive signals from the UEs 430 and transmit signals received from a network (not shown) via an Internet connection as over a DSL network to the UEs 430, using the radio resources. Notably, the femto BS 420 and the macro BS 410 do not communicate with each other using the radio resources. Compared to a resource allocation scheme in which a macro BS allocates to a relay station radio resources for communications between a relay station and the macro BS and radio resources for communications between the relay station and UEs serviced by the relay station, the hierarchical scheduling scheme leads to more efficient use of radio resources.

In an exemplary embodiment of the present invention, it may be set that radio resources that a macro BS has allocated to a femto BS are used for communications between UEs in a femto cell under management of the femto BS.

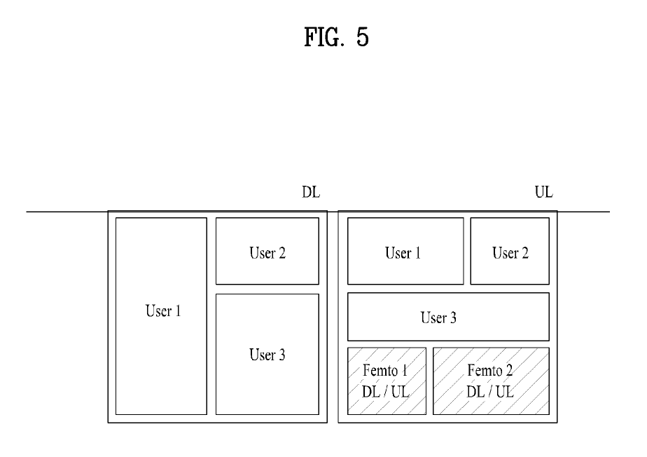

FIG. 5 illustrates a concept of radio resource allocation according to an exemplary embodiment of the present invention.

Referring to FIG. 5, a macro BS may allocate downlink (DL) and uplink (UL) resources to UEs requesting radio resources, specifically UEs included in a macro UE group, User 1, User 2 and User 3. The macro BS may also allocate radio resources to femto BSs, Femto 1 and Femto 2 requesting the radio resources in the same manner as the UEs, in the same manner as is done for the UEs. The macro BS may transmit DL signals to User 1, User 2 and User 3 in the allocated DL radio resources and receive UL signals from User 1, User 2 and User 3 in the allocated UL radio resources. In contrast, the radio resources allocated to Femto 1 and Femto 2 by the macro BS are used only for DL and UL communications between Femto 1 and Femto 2 and femto

UEs, not for communications between Femto 1 and Femto 2 and the macro BS or for communications between the macro BS and user device a relay station is allocated radio resources UEs serviced by Femto 1 and Femto 2. In the exemplary embodiment of the present invention, the femto BSs transmit data received from the UEs included in their femto cells to a network of a communication service provider over the Internet in the allocated radio resources.

It may further be contemplated as another exemplary embodiment of the present invention that spatial reuse is implemented based on the property that radio resources allocated to a particular femto cell are confined to radio communications within the femto cell.

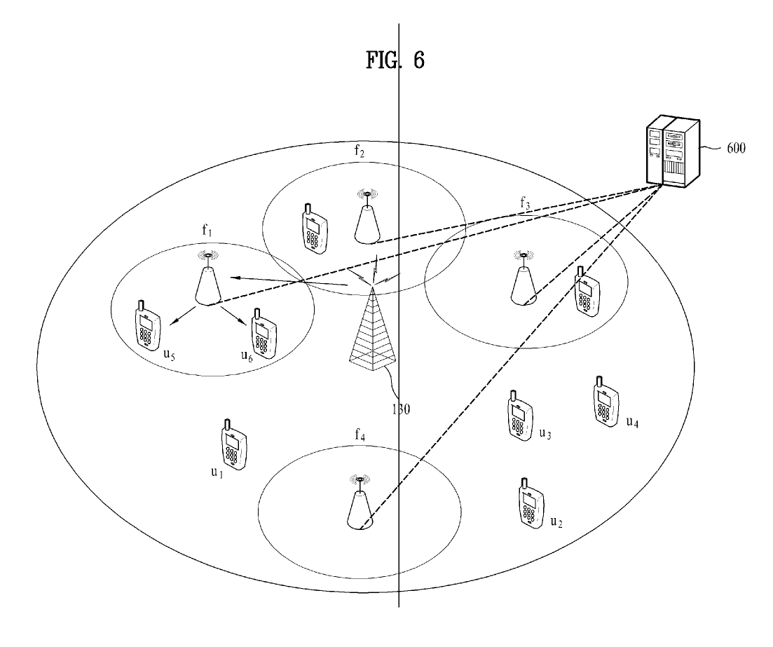

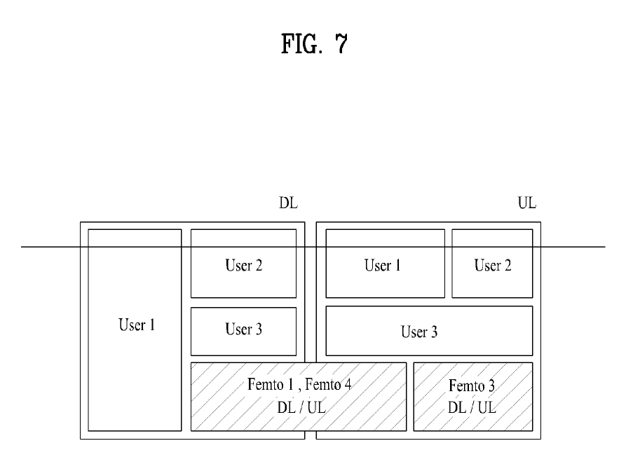

FIGS. 6 and 7 illustrate a radio resource scheduling method taking into account spatial reuse according to another exemplary embodiment of the present invention.

In the exemplary embodiment of the present invention, UEs are grouped into a macro UE group that a macro BS directly services and a femto UE group that the macro BS services through a femto BS. Also, when requesting radio resource allocation to the macro BS, a femto BS transmits its identification information and location information in addition to the radio resource allocation request to the macro BS. The macro BS may identify that the entity requesting radio resources is the femto BS, not a UE and allocate the same resources to femto BSs that are spatially apart, based on the identification information and the location information. FIG. 7 illustrates an exemplary case where a macro BS allocates the same radio resources to femto BSs, Femto 1 and Femto 4. Considering that the use of radio resources allocated to a femto BS is confined to a femto cell covered by the femto BS, use of the same radio resources in spatially remote femto cells may not affect communication quality significantly.

A further exemplary embodiment of the present invention may be contemplated, in which a central controller 600 is installed such that each femto BS may transmit its femto BS information (e.g. a neighbor femto BS list) and location information to the central controller 600, as illustrated in FIG. 6. In this case, the central controller 600 may control radio resource allocation to femto cells in the manner that achieves spatial reuse.

The exemplary embodiments of the present invention described above with reference to FIGS. 6 and 7 enable more efficient use of radio resources by adding a configuration that enables a femto BS and a UE to be distinguished from each other and a configuration that implements spatial reuse according to the locations of femto BSs. The resulting minimal modification to a system may increase radio resource efficiency.

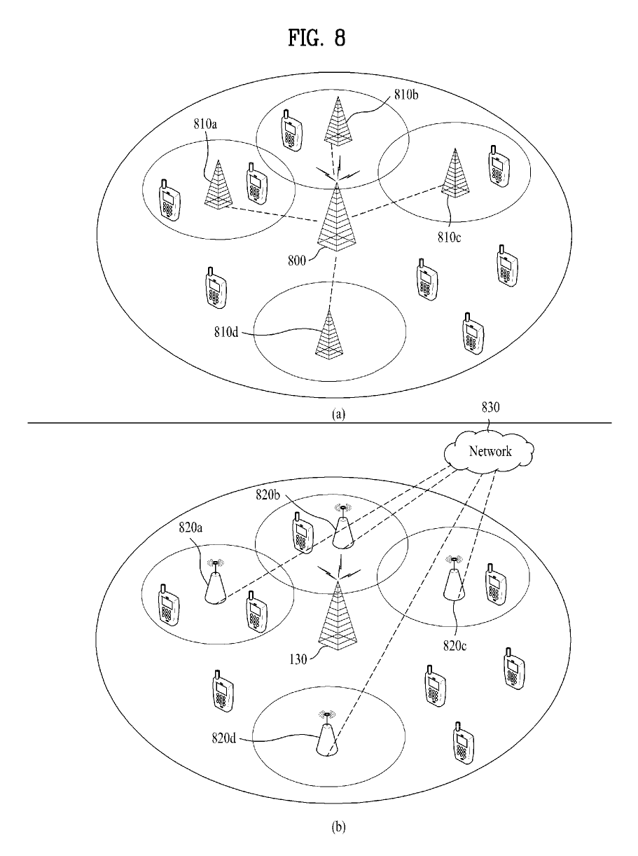

FIGS. 8(a) and 8(b) are views comparing a femto BS-based scheduling method according to an exemplary embodiment of the present invention with a relay station-based scheduling method.

Specifically, FIG. 8(a) illustrates relay station-based scheduling and FIG. 8(b) illustrates femto BS-based scheduling.

Conventionally in a wireless communication system using relay stations 810a to 810d, a macro BS 800 allocates radio resources to each UE and yet a DL/UL signal for a UE is transmitted between the macro BS 800 and the UE through a relay station. On the other hand, when scheduling is performed using femto BSs 820a to 820d, the femto BSs 820a to 820d are allocated resources from a macro BS 130 and in turn allocate the radio resources to UEs serviced by the femto BSs 820a to 820d, for communications between the femto BSs 820a to 820d and the UEs.

While the relay stations 810a to 810d transmit data received from UEs to a service provider network through the macro BS 800 in the relay station-using wireless communication system, the femto BSs 820a to 820d transmit data received from UEs directly to a service provider network over a DSL network or the like in the femto BS-using system according to the exemplary embodiment of the present invention.

Also, the macro BS 800 distinguishes a relay station from a UE and separately allocates resources for communications between the macro BS 800 and the relay station and resources for communications between the relay station and a UE, thereby requiring a modification to the macro BS 800 in the relay station-using wireless communication system. In contrast, the hierarchical scheduling using femto BSs according to the exemplary embodiment of the present invention obviates the need for modifying the macro BS 130 or causes a minimal modification to the macro BS 130.

The differences between the relay station-using system and the femto BS-using system are listed in Table 2 below.

TABLE 2

| | | | System |
|---|---|---|---|
| | Scheduling | Data Transfer | Modification |
| Relay | Conventional | To Macro | Yes |
| Femto | Hierarchical | To Network | No |

Now a description will be made of a configuration of a femto BS for implementing the above-described exemplary embodiments of the present invention.

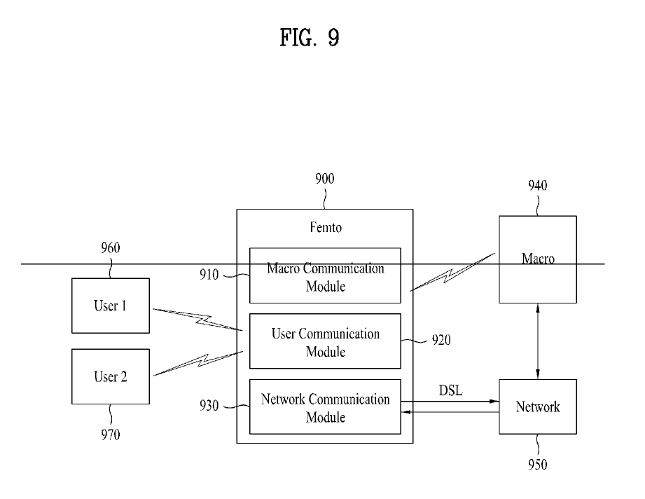

FIG. 9 is a block diagram of a femto BS according to an exemplary embodiment of the present invention.

Referring to FIG. 9, a femto BS 900 according to an exemplary embodiment of the present invention may include a macro communication module 910 for communicating with a macro BS 940, a user communication module 920 for communicating with UEs 960 and 970 serviced by the femto BS 900, and a network communication module 930 for communicating with a network 950. The femto BS 910 may transmit a resource allocation request signal using a predetermined ID having a UE ID format to the macro BS 940 through the macro communication module 910 and be allocated resources from the macro BS in response to the ID. In accordance with the exemplary embodiment of the present invention, the macro communication module 910 may be a cellular mobile communication module and a radio resource allocation procedure may be performed according to a cellular mobile communication scheme in the same manner as a UE requests radio resources to the macro BS 940 and is allocated the radio resources from the macro BS 940.

Meanwhile, the femto BS 900 may communicate with the UEs 960 and 970 through the user communication module 920 using the radio resources allocated through the macro communication module 910. That is, the femto BS 900 may receive signals from the UEs 960 and 970 in the allocated radio resources and transmit signals received from the network 950 through the network communication module 930 to the UEs 960 and 970 in the allocated radio resources.

The femto BS 900 may transmit signals received from UEs to the network 950 in the allocated radio resources over the Internet through the network communication module 930, rather than it communicates with the macro BS 940 in the allocated radio resources. Preferably, the network communication module 930 may be a DSL-based Internet communication module. Also, the femto BS 900 may receive a signal that is directed from the network 950 to a UE through the network communication module 930 connected to the network 950 over the Internet.

### MODE FOR INVENTION

Various embodiments have been described in the best mode for carrying out the invention.

### INDUSTRIAL APPLICABILITY

The hierarchical scheduling schemes according to the above-described exemplary embodiments of the present invention are applicable to a variety of communication systems using femto BSs or equivalent small BSs, such as 3GPP LTE, an advanced system of its kind, systems based on the IEEE 802 family of standards, etc.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method for scheduling User Equipments (UEs) in a femto Base Station (BS) in a mobile communication system having a hierarchical cell structure, the method comprising:
transmitting a resource allocation request signal to a macro BS using a predetermined identifier (ID) having a UE ID format;
receiving radio resource allocation information about resources allocated in relation to the predetermined ID from the macro BS;
allocating the allocated radio resources to one or more UEs;
receiving a signal from the one or more UEs using the allocated radio resources; and
transmitting the signal received from the one or more UEs to a network via an Internet connection.

2. The method according to claim 1, wherein the mobile communication system provides a service to a plurality of UEs and the plurality of UEs are grouped into a macro UE group serviced directly by the macro BS and a femto UE group serviced by the femto BS.

3. The method according to claim 2, wherein the femto BS wirelessly communicates with the macro BS, the one or more UEs are included in the femto UE group, and the femto BS transmits a signal to the one or more UEs in the allocated radio resources.

4. The method according to claim 3, wherein the allocated radio resources are confined to communications between the femto BS and the one or more UEs included in the femto UE group.

5. The method according to claim 1, wherein the transmission comprises transmitting the signal received from the one or more UEs directly to the network via the Internet connection without making the signal pass through the macro BS.

6. The method according to claim 1, wherein the predetermined ID is a UE ID allocated to the femto BS by the macro BS.

7. The method according to claim 1, wherein the UE ID is used as a group ID of the one or more UEs.

8. The method according to claim 1, wherein the predetermined ID is an ID of one of the one or more UEs.

9. The method according to claim 1, wherein the one or more UEs communicate with another UE using the allocated radio resources.

10. The method according to claim 2, further comprising transmitting to the macro BS information by which the macro BS distinguishes the femto BS from the plurality of UEs, wherein the macro BS allocates the radio resources allocated to the femto BS to another femto BS.

11. The method according to claim 1, further comprising transmitting neighbor femto BS information to a central controller, wherein the central controller allocates the radio resources allocated to the femto BS to another femto BS.

12. A femto Base Station (BS) in a mobile communication system that has a hierarchical cell structure and provides a service to a plurality of User Equipments (UEs), the femto BS comprising:
a macro communication module for transmitting a resource allocation request signal to a macro BS using a predetermined Identifier (ID) having a UE ID format and receiving radio resource allocation information about radio resources allocated in relation to the predetermined ID from the macro BS;
a user communication module for allocating the radio resources allocated by the macro BS to one or more UEs and receiving a signal from the one or more UEs using the allocated radio resources; and
a network communication module for transmitting the signal received from the one or more UEs to a network via an Internet connection.

13. The femto BS according to claim 12, wherein the macro communication module and the user communication module are cellular mobile communication modules and the network communication module is a Digital Subscriber Line (DSL)-based Internet communication module.
